(19) United States
(12) Patent Application Publication
(10) Pub. No.: US 2007/0245417 A1
(43) Pub. Date: Oct. 18, 2007

(54) Malicious Attack Detection System and An Associated Method of Use

(76) Inventors: Hojae Lee, Chesterfield, MO (US); Indra Gunawan Harijono, St. Louis, MO (US); Prudhvi Nadh Nooney, Maryville, IL (US); Uooyeol Yoon, St. Louis, MO (US)

Correspondence Address: THOMPSON COBURN, LLP, ONE US BANK PLAZA, SUITE 3500, ST LOUIS, MO, 63101, US

(21) Appl. No.: 11/279,979

(22) Filed: Apr. 17, 2006

(51) Int. Cl. G06F 12/14

(52) U.S. Cl. 726/22

(57) ABSTRACT

A malicious attack detection system and associated method of use is disclosed. This includes receiving and parsing a header frame of a data packet into header information and internet protocol (“IP” or “TCP/IP”) addresses, checking the header information for a potential malicious attack condition and if present then a constraint filter result is generated, comparing the internet protocol (“IP”) addresses to determine if an internet protocol (“IP”) address had been previously received, determining if an internet protocol (“IP”) address had been previously received, determining the number of constraint filter results to determine if an incremented count is above a predetermined threshold during a predetermined threshold time period, and dropping at least one data packet based on a determination. Preferably, but not necessarily, the process is carried out at wire-speed meaning when a new data packet arrives, all processing above is complete with regard to the previous data packet.

### TECHNICAL FIELD OF THE INVENTION

The present invention relates to server protection, particularly an improved technique for detecting and preventing a malicious attack, e.g., denial of service (“DoS”) and port scan, for servers utilizing a global computer network, e.g., Internet, which preferably, but not necessarily occurs at wire speed.

### BACKGROUND OF THE INVENTION

Many entities, such as corporations, network their computers in order to share information. In addition, these entities usually desire to share at least some information with computers outside their network through the use of a global computer network, e.g., Internet, typically through a website. This sharing of information outside the network is accomplished using a computer server which provides external computers a connection to network to a global computer network, e.g., Internet.

Unfortunately, a malicious computer user can use the internet connection to disrupt the network's communications over the internet, gain access to confidential data, or erase data. One example of such an attack is the denial of service (“DoS”) attack where the attacker attempts to deny the victim's access to certain resources. A denial of service (“DoS”) attack can be achieved through various methods including consuming and exhausting the server's processor e.g., CPU, memory and network connections.

In order to establish a network connection, there must be a two-way communication or a hand-shaking process between the external computer and the server, A basic schematic of a network is generally indicated in numeral 1, which is shown in FIG. 1. For example, an external (client) computer 2 would send a request to the server for service through a network 6, e.g., global computer network. In response to this request, the server allocates memory space and processing time, sends a response back to the computer, and waits for the computer to reply. The external computer with malicious intent 4, i.e., attacker, could send numerous requests for service to the server 3 but never reply back to the server. The external computer applies a common technique called “IP address spoofing” 9, which inserts an IP address that looks legitimate or looks to come from a trusted source (computer). IP address spoofing 9 causes the server 3 to believe that numerous (multiple) connections are requested to be established. The server 3 then waits for a reply that it will never receive while reserving and wasting memory and processing time. While waiting and also receiving additional data packets, the server 3 can run out of memory, processing space, or connections to the network. As the result of consuming too much memory, the server 3 will refuse to serve any further legitimate requests 11 from any other legitimate external computers 2. Eventually the requests could be so numerous that the server 3 cannot provide not only connections to the legitimate users but can also flood and jam the whole network and the server's communications through the internet will essentially shut down 8. This could result in loss of e-mail, internet access, and/or web server function.

Another complicated situation can further arise, when a malicious attacker pretends to act as the (legitimate) server 5, which is not responsive anymore due to the exhaustion (and being busy), to serve legitimate external computers or users 2. The attacker 7 can then request confidential data 12 from other legitimate computers or users 2 and the legitimate computers or users 2 are not necessarily aware of being attacked 7 by a faked server 5, as shown in FIG. 1.

Other examples of these attacks include flooding the server with a large number of data packets in order to consume all the available bandwidth of the network, thereby denying legitimate users access to the network, or consuming available disk space by causing the server to execute numerous programs or scripts.

In addition, a malicious computer user can use port scanning to obtain information about network communication ports such as checking if the port is open or closed or what services or programs are using the port. The attacker can check for vulnerabilities in the services using the port and exploit them to gain access to the system where the attacker can erase data or perform other malicious acts.

In high speed network traffic, detecting malicious attacks and preventing the system from getting attacked in a timely and proper manner can prove to be crucial for enterprise. A wire-speed attack detection would be very helpful in not only detecting the attacks at the right time but also blocking the attacks (from attacking further) at the earliest possible detection time. Without correct detection at the right time, the attacks not only can penetrate the system and create a major denial of service (“DoS”) attack but also can cause permanent data loss. The present invention is directed to overcoming one or more of the problems set forth above.

### SUMMARY OF INVENTION

In an aspect of the invention, the present invention includes a denial of service attack and/or a port scan detection system that receives an internet data packet (“TCP/IP” or “IP”) and drops the packet from the server if it determines that the packet is an attempt at a denial of service attack or a port scan. The packet is preferably, but not necessarily, dropped at wire-speed. Wire-speed is defined as the (“TCP/IP” or “IP”) data packet processing speed, which is needed in order to detect a denial of service (“DoS”) or port scan attack, less or equal than the time required from an individual (“TCP/IP” or “IP”) data packet that enters the system until the time the next (“TCP/IP” or “IP”) data packet enters the system. In other words, by the time the next (adjacent) (“TCP/IP” or “IP”) data packet arrives the process of denial of service (“DoS”) and/or port scan detection on the previous (“TCP/IP” or “IP”) data packet must have been successfully completed for a wire-speed condition to be present. Detection of such attacks also preferably includes system checks if the source and the destination address of incoming internet packets match the source and destination address for previously stored packets. The system counts the number of packets from the same source or destination IP address in a specified time threshold and prevents the attack by dropping the packet from the system if the count is above a certain threshold.

It is preferred, but not necessary, to have wire-speed denial of service (“DoS”) and/or port scan detector in which the servers are deployed to serve high bandwidth and high throughput environment such as in a “server farm” configuration. The absence of wire-speed detection can allow many attackers to evade (common and traditional) detection techniques as they also can exhaust the detection system itself or the detection system will be forced to drop incoming (“TCP/IP” or “IP”) data packets causing significant packet losses and delays.

In another aspect of the present invention, a malicious attack detection system is disclosed. The system includes a header parsing function for receiving and parsing a header frame of a data packet into header information and internet protocol (“IP”) addresses, a constraint filter function that checks the header information for a potential malicious attack condition, wherein if a potential malicious attack condition is present then a constraint filter result is generated, a comparison function then compares the internet protocol (“IP”) addresses to determine if an internet protocol (“IP”) address had been previously received, a detection function that determines that if the comparison function had determined that an internet protocol (“IP”) address had been previously received, then the constraint filter result increments a count and then determines if the count is above a predetermined threshold during a predetermined threshold time period, a control function that provides control signal to drop at least one data packet from the system based on the detection function determining that the count is above a predetermined threshold during a predetermined threshold time period, and at least one processor that provides the header parsing function, the constraint filter function, the detection function and the control function.

In still another aspect of the present invention, a malicious attack detection system is disclosed. The system includes a header parsing function for receiving and parsing a header frame of a data packet into header information and internet protocol (“IP”) addresses at wire-speed, a constraint filter function that checks the header information at wire-speed for a potential malicious attack condition, wherein if a potential malicious attack condition is present then a constraint filter result is generated, wherein the potential malicious attack condition is selected from the group consisting of a denial of service (“DoS”) attack or a port scan, wherein the constraint filter function includes a plurality of constraint conditions that can be selectively activated, a comparison function compares the internet protocol (“IP”) addresses, at wire-speed, to determine if an internet protocol (“IP”) address had been previously received, a detection function, operating at wire-speed, that determines that if the comparison function had determined that an internet protocol (“IP”) address had been previously received, then the constraint filter result increments a count and then determines if the count is above a predetermined threshold during a predetermined threshold time period, wherein the detection function includes a plurality of counters and a corresponding plurality of threshold counter value comparisons and an associated time interval filter function with a plurality of time intervals and a corresponding plurality of threshold time interval values, a control function, operating at wire-speed, that provides control signal to drop at least one data packet from the system based on the detection function determining that the count is above a predetermined threshold during a predetermined threshold time period, at least one processor that provides the header parsing function, the constraint filter function, the detection function and the control function, and an interface associated with the at least one processor for providing control for the constraint filter function and the control function.

In yet another aspect of the present invention, a method for detecting a malicious attack with at least one processor is disclosed. The method includes receiving and parsing a header frame of a data packet into header information and internet protocol (“IP”) addresses, checking the header information for a potential malicious attack condition, wherein if a potential malicious attack condition is present then a constraint filter result is generated, comparing the internet protocol (“IP”) addresses to determine if an internet protocol (“IP”) address had been previously received, determining if during the step of comparing the internet protocol (“IP”) addresses that an internet protocol (“IP”) address had been previously received, determining the number of constraint filter results to determine if an incremented count is above a predetermined threshold during a predetermined threshold time period, and dropping at least one data packet from the system based on the detection function determining that the count is above a predetermined threshold during a predetermined threshold time period.

In still yet another aspect of the present invention, a method for detecting a malicious attack with at least one processor is disclosed. The method includes receiving and parsing a header frame of a data packet into header information and internet protocol (“IP”) addresses at wire-speed, checking the header information for a potential malicious attack condition at wire-speed, wherein if a potential malicious attack condition is present then a constraint filter result is generated through a selective activation of plurality of constraint conditions and the potential malicious attack condition is selected from the group consisting of a denial of service (“DoS”) attack or a port scan, comparing the internet protocol (“IP”) addresses to determine if an internet protocol (“IP”) address had been previously received at wire speed, determining if during the step of comparing the internet protocol (“IP”) addresses that an internet protocol (“IP”) address had been previously received at wire-speed, determining the number of constraint filter results to determine if an incremented count is above a predetermined threshold during a predetermined threshold time period at wire speed, and dropping at least one data packet from the system, at wire speed, based on the detection function determining that the count is above a predetermined threshold during a predetermined threshold time period with a plurality of counters and a corresponding plurality of threshold counter value comparisons and a plurality of time intervals and a corresponding plurality of threshold time interval values.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 illustrates a general schematic of a computer network illustrating concepts of a DoS attack, (“IP”) Internet Protocol address spoofing, faked servers and other types of malicious attacks known in the prior art;

FIG. 2 illustrates a schematic view of an imminent malicious attack, i.e., denial of service and port scan, detection system according to the present invention; and

FIG. 3 illustrates a flow chart of the process associated with an imminent malicious attack, i.e., denial of service and port scan, detection system according to the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as to obscure the present invention.

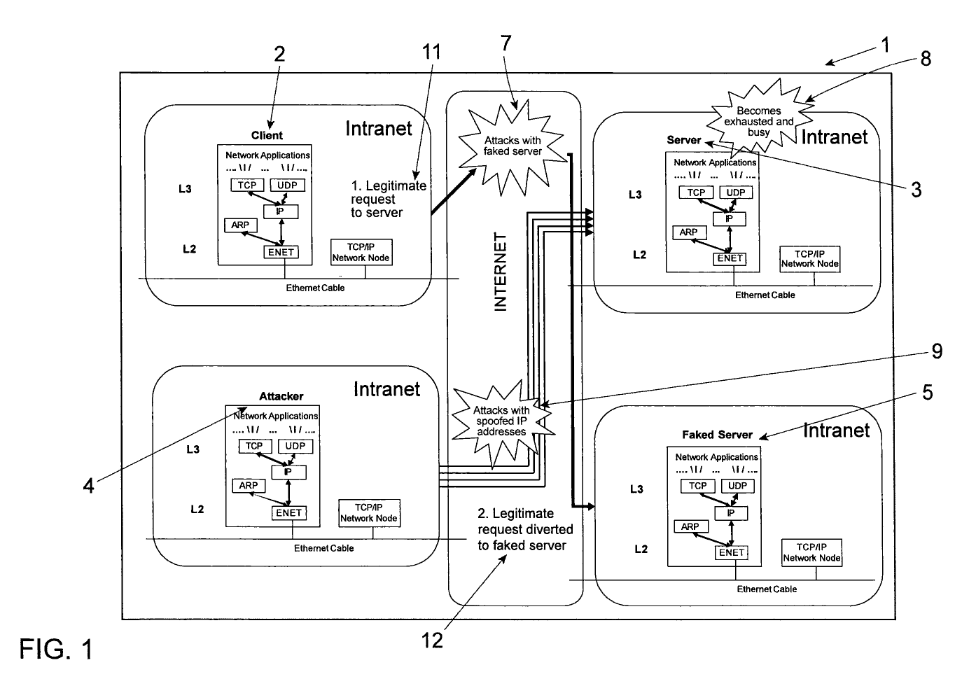

Referring to the accompanying drawings, FIG. 1 illustrates a schematic view of a malicious attack detection system, e.g., denial of service (“DoS”) and port scan, according to the present invention that is generally indicated by numeral 10. In this present invention, a header frame is received, e.g., an “L2” frame that is typically associated with an Ethernet frame, as indicated by numeral 15 and then passed to a first-in/first-out (“FIFO”) memory buffer, which is generally indicated by numeral 104.

This header frame is also simultaneously passed into a parsing block 20 that receives the header frame. The header frame is parsed within the parsing block 20 to identify the type of header frame, e.g., L2, and to locate the first bytes of other header frames (it is synonymous to “TCP/IP” data packet), e.g., an “L3” header that is associated with an Internet Protocol (“IP”) header and an “L4” header that is associated with the Transmission Control Protocol (“TCP”) header. The parsing block 20 also locates other header information such as the Transmission Control Protocol (“TCP”) flag and the timing information. The destination internet protocol address (“DIP”) and the source internet protocol address (“SIP”) 52 is sent to a detection block that is generally indicated by numeral 50. In the detection block 50, the destination internet protocol address (“DIP”) and the source internet protocol address (“SIP”) 52 is sent to an internet protocol (“IP”) address storage block 54.

The remaining header information 22, e.g., L2 and/or L3 and/or L4 header frames, as well as transmission control protocol (“TCP”) flag and timing information, are sent to a constraint filter block indicated by numeral 30. The constraint filter block 30 checks the remaining header information 22 for a potential malicious attack, e.g., denial of service (“DoS”) and port scan. The constraint filter block 30 can include a plurality of constraints, e.g., illustrative constraint 1 indicated by numeral 32, illustrative constraint 2 indicated by numeral 34, up to illustrative constraint N indicated by numeral 36. In the first constraint filter block 30, filter conditions are activated and deactivated per detection type through a processor interface block indicated by numeral 40. When one or more conditions are detected, the constraint filter results 66 are generated, which are sent to a state machine control block 68 as well as a count accumulator comparison block that is generally indicated by numeral 72.

The filter conditions are used to check for each type of imminent malicious attack, i.e., denial of service (“DoS”) and port scan. The processor interface block 40 is electrically connected to the constraint filter block 30 and activates and deactivates the filter conditions per detection type. The detection block 50 is electrically connected to the header parsing block 20, the constraint filter block 30, and the processor interface block 40. The detection block 50 receives and stores source and destination internet protocol (“IP”) addresses received from the header parsing block 20. The detection block 50 also receives the constraint filter results from the constraint filter block 30 and determines if a threshold attack count is exceeded or if a threshold time interval between attacks is exceeded.

Preferably the detection block 50 includes a content-addressable memory (“CAM”) lookup block 64. The CAM lookup block 64 is electrically connected to the header parsing block 20 and receives the source and destination internet protocol (“IP”) addresses 52 and looks them up to see if they are already stored in the memory of the CAM lookup block 64. A content-addressable memory (“CAM”) is an integrated circuit that can search a list at high speed to provide a corresponding result. Content-addressable memory (“CAM”) possesses a unique memory architecture for highly dense integrated digital circuit that enables storing information at the location that is indexed by its content. Retrieving the content, one only requires just the content. Consequently, when compared to any traditional retrieval techniques such as Linked List, Hash Table, and so forth, if realized into a logic array, the retrieval of the content may only require a couple of cycles. Due to its character, CAM provides significant help to speed up information retrieval process and thus can be used to realize denial of service (“DoS”) and port scan attacks at a high speed, e.g., wire-speed. The CAM lookup block 64 is configured with a list of selector entries. These selector entries are associated with the contents that bear the information. Each selector entry has a corresponding result. When the CAM lookup block 64 receives an input selector, it searches the list of selector entries for a match. The search is accomplished at high speed by concurrently comparing each selector entry to the input selector.

If the result of the lookup process is negative, then the internet protocol (“IP”) address was not previously received. If the result of the lookup process is positive, then there is a match and the internet protocol (“IP”) address was previously received. In either case, either the match result 70 is sent to the internet protocol (“IP”) storage control block 56 as well as the count accumulation/comparison block 72.

The match result 70 as well as the constraint filter results 66 are received by the count accumulation/comparison block 72. There are a plurality of counters, e.g., illustrative counter 1 indicated by numeral 74, illustrative counter 2 indicated by numeral 78, up to illustrative counter N indicated by numeral 82 where each counter is associated with a threshold comparison value, e.g., illustrative threshold comparison 1 indicated by numeral 76, illustrative threshold comparison 2 indicated by numeral 80, up to illustrative threshold comparison N indicated by numeral 84. This value of threshold attack counts is set by the interface block 40. The count accumulation/comparison block 72 is electrically controlled and connected to a count threshold control per attack/attempt type 44 located in the processor interface block 40.

There is also a time interval filter block indicated by numeral 90 that includes a plurality of time interval values e.g., an illustrative time interval value 1 indicated by numeral 92, an illustrative time interval value 2 indicated by numeral 96, up to an illustrative time interval N indicated by numeral 100. Each of the time interval values 92, 96 and 100 is associated with a threshold comparison value, e.g., an illustrative threshold comparison 1 indicated by numeral 94, an illustrative threshold comparison 2 indicated by numeral 98, up to an illustrative threshold comparison N indicated by numeral 102. The time interval filter block 90 is electrically controlled and connected to a time interval threshold control per attack/attempt type 46 located in the processor interface block 40.

The first constraint filter results 66 begin to increment the counts within the count accumulation/comparison block 72 according to the types of constraints in the time interval filter block 90 to see if the incremented count is over the count threshold in a defined time interval. If the incremented counts are over the thresholds, a comparison result and detected type 86 is generated and sent to a frame, e.g., header frame “L2”, readout control block 88 as well as a detected type report generator 48.

The frame, e.g., header frame “L2”, readout control 88 generates a readout control function 89 that operates to drop the associated data packet that is located in a frame dropping block 106, that was received from the previously referenced first-in/first-out (FIFO) memory buffer 104. When the data packet having an associated header frame, e.g., “L2,” is dropped, there is a detected frame report generator 49 that is activated as well as a readout indicating that a data packet with a particular header frame e.g., “L2,” has been dropped 108.

The previously referenced internet protocol (“IP”) address storage block 56 receives the match result 70 from the CAM lookup block 64. The internet protocol (“IP”) address storage block 56 controls to share a predetermined and potentially limited number of bins for storing internet protocol (“IP”) addresses with those present in the detection block 50 based on a predetermined algorithm, e.g., linked list. The internet protocol (“IP”) address storage block 56 generates an allocated internet protocol (“IP”) address 57 that are checked within the detection block 50. When the match result 70 from the CAM lookup block 64 is positive, meaning the internet protocol (“IP”) address was previously received, then the allocated internet protocol (“IP”) address 57 remains the same and if the match result 70 from the CAM lookup block 64 is negative, meaning the internet protocol (“IP”) address was not previously received, then the value of the allocated address 57 is incremented to include this new value.

The internet protocol (“IP”) address storage block 56 stores the received internet protocol (“IP”) address at the address location provided by the allocated internet protocol (“IP”) address 57. This allocated internet protocol (“IP”) address 57 is provided to the previously referenced internet protocol (“IP”) address storage block 54. During the last half of the states, the update/reset address generation block 58 generates addresses to reset and update the contents of the CAM Lookup Block 64 with a command to either erase the internet protocol (“IP”) address 60 or update the internet protocol (“IP”) address 62.

The state machine control block 68 is electrically connected to the constraint filter block 30 and receives the constraint filter results 66. The state machine control block 68 is also electrically connected to and generates predefined states to run the CAM lookup block 64, the IP address storage control block 56, the internet protocol (“IP”) address storage block 54, the update/reset address generation block 58, the count accumulation/comparison block 72, the time interval filter block 90, and the frame readout control block 88.

The detection block 50 checks for a match between the received source and destination internet protocol (“IP”) addresses and increases counts based on the constraint filter results 66. When the count threshold is exceeded in a time interval threshold, the detection block 50 generates a signal to drop the internet frame from the server network.

When the header parsing block 20 is receiving the internet data packet, this data packet is also received by a frame receiving block 104. The frame receive block 104 operates as a first-in/first out memory buffer to store the internet frames during the detection process. The frame receive block 104 is electrically connected to a frame dropping control block 106. The frame dropping control block 106 receives the internet data packet from the frame receive block 104. The frame dropping control block 106 is also electrically connected to the detection block 50 through the frame, e.g., header frame “L2,” readout control block 88 and receives the readout control signal 89. The detection block 50 communicates whether the frame dropping control block 106 should drop or transmit the internet frame to the computer network, e.g., server network on a global computer network, based on whether a denial of service (“DoS”) or port scan attack was detected, thereby preventing an attack.

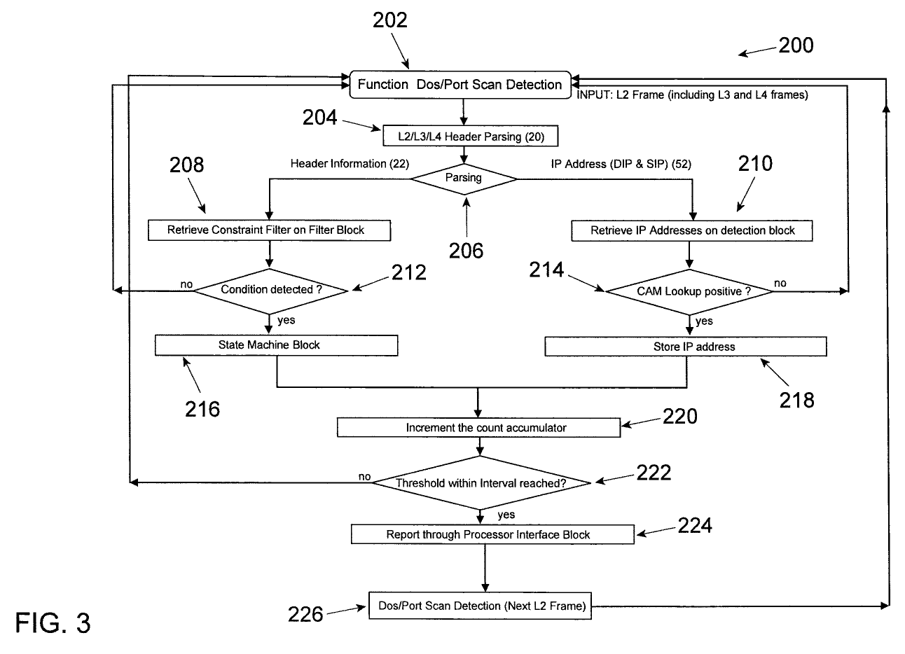

Referring now to FIG. 3, which is a schematic diagram of the detection process of a denial of service (“DoS”) attack or port scan that preferably, but not necessarily occurs at wire speed and is generally indicated by numeral 200. In the description of flowcharts, the functional explanation marked with numerals in angle brackets, <nnn>, will refer to the flowchart blocks bearing that number.

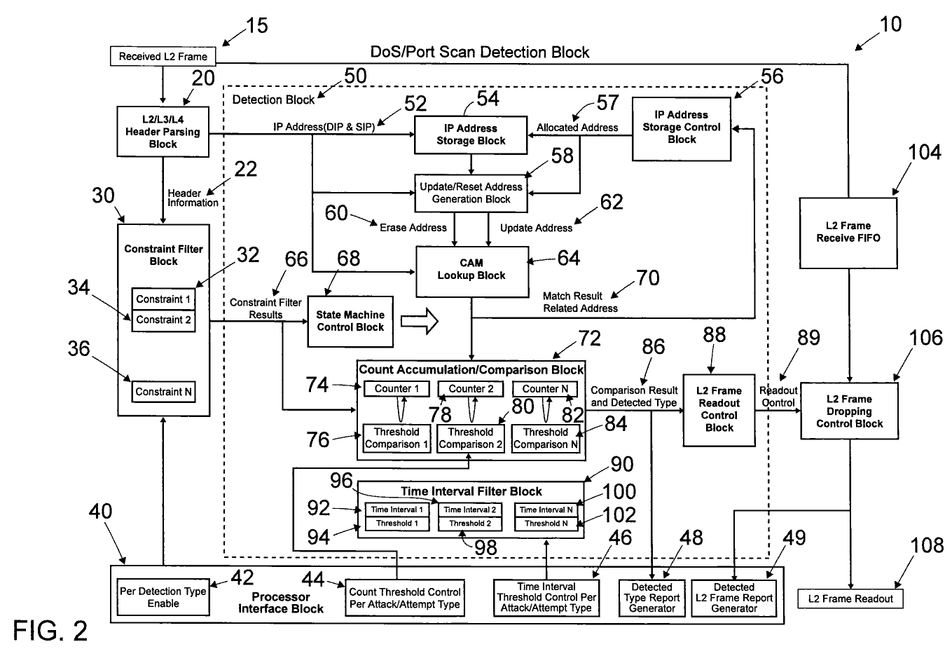

The general operation begins at step <202>. As also shown in FIG. 2, the header frame is parsed within the parsing block 20, as shown by step <204> to identify the type of header frame, e.g., L2, and to locate the first bytes of other header frames (it is synonymous to “TCP/IP” data packet), e.g., an “L3” header that is associated with an Internet Protocol (“IP”) header and an “L4” header that is associated with the Transmission Control Protocol (“TCP”) header. The parsing block 20 also locates other header information such as the Transmission Control Protocol (“TCP”) flag and the timing information. This header information 22, e.g., L2 and/or L3 and/or L4 header frames, as well as transmission control protocol (“TCP”) flag and timing information, are parsed indicated by process step <206> and sent to a constraint filter block indicated by numeral 30, which is shown in FIG. 2 and is process step <208> that is shown in FIG. 3.

A determination is then made if a malicious attack is detected, e.g., port scan or denial of service (“DoS”) attack, as indicated by numeral <212>. If this determination is negative, then the process returns to the beginning of the process indicated by process step <202>.

If the determination is positive with one or more conditions being detected, the constraint filter results 66 are generated, which are sent to a state machine control block 68 <216>, which is shown in FIG. 2 and is process step <216> that is shown in FIG. 3. These constraint filter results are then sent to the count accumulator comparison block 72, which is shown in FIG. 2 and is process step <220> that is shown in FIG. 3.

Simultaneously, from process step <206>, the parsed destination internet protocol address (“DIP”) and the source internet protocol address (“SIP”) 52 are sent to a detection block that is generally indicated by numeral 50, as shown in FIG. 2, and indicated by process step <210>, shown on FIG. 3. In the detection block 50, the destination internet protocol address (“DIP”) and the source internet protocol address (“SIP”) 52 is sent to an internet protocol (“IP”) address storage block 54. Preferably the detection block 50 includes a content-addressable memory (“CAM”) lookup block 64. The CAM lookup block 64 receives the source and destination internet protocol (“IP”) addresses 52 and looks them up to see if they are already stored in the memory of the CAM lookup block 64, which is shown in FIG. 2. If the CAM lookup is negative, the process returns to the beginning of the process as indicated by process step <202>, as shown in FIG. 3. If the CAM lookup is positive, the internet protocol (“IP”) address storage block 56 stores the received internet protocol (“IP”) address at the address location provided by the allocated internet protocol (“IP”) address 57, which is shown in FIG. 2.

This allocated internet protocol (“IP”) address 57 is provided to the previously referenced internet protocol (“IP”) address storage block 54. During the last half of the states, the update/reset address generation block 58 generates addresses to reset and update the contents of the CAM Lookup Block 64 with a command to either erase the internet protocol (“IP”) address 60 or update the internet protocol (“IP”) address 62. This process step is shown by <218> in FIG. 4. These CAM lookup results are then sent to the count accumulator comparison block 72, which is shown in FIG. 2 and is process step <220> that is shown in FIG. 3.

Therefore, the constraint filter results are then sent to the count accumulator comparison block 72, which is shown in FIG. 2 and the CAM lookup results are then sent to the count accumulator comparison block 72, which is shown in FIG. 2 which are both indicated as process step <220> that is shown in FIG. 3.

A determination is then made if the detection block 50 also receives the constraint filter results from the constraint filter block 30 and determines if a threshold attack count is exceeded or if a threshold time interval between attacks is exceeded which is shown in FIG. 2, and is process step <222> that is shown in FIG. 3. If this determination is negative then the process goes back to the beginning of the process indicated by process step <202>. If this determination is positive, then a report function is activated with a detected type report generator 48 and/or detected frame report generator 49 or a through the processor interface block 40, which is shown in FIG. 2, and is process step <224> that is shown in FIG. 3.

A frame receive block 104 operates as a first-in/first out memory buffer to store the internet frames during the detection process as shown in FIG. 2. The frame receive block 104 is electrically connected to a frame dropping control block 106. The frame dropping control block 106 receives the internet data packet from the frame receive block 104. The frame dropping control block 106 is also electrically connected to the detection block 50 through the frame, e.g., header frame “L2,” readout control block 88 and receives the readout control signal 89. The detection block 50 communicates whether the frame dropping control block 106 should drop or transmit the internet frame to the computer network, e.g., server network on a global computer network, based on whether a denial of service (“DoS”) or port scan attack was detected, thereby preventing an attack, which is shown in FIG. 2 where the frame is then either passed or dropped <224> where a new “L2” header frame is then received and the process returns to the beginning of the process, as shown in FIG. 3 as process step <202>. Preferably, but not necessarily, this occurs at wire-speed.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The term “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the other accompanying drawings. All such changes, modifications, variations and other uses and applications which do not depart from the spirit and scope of the invention are deemed to be covered by the invention which is limited only by the claims that follow.

1. A malicious attack detection system comprising:
a header parsing function for receiving and parsing a header frame of a data packet into header information and internet protocol (“IP”) addresses;
a constraint filter function that checks the header information for a potential malicious attack condition, wherein if a potential malicious attack condition is present then a constraint filter result is generated;
a comparison function compares the internet protocol (“IP”) addresses to determine if an internet protocol (“IP”) address had been previously received;
a detection function that determines that if the comparison function had determined that an internet protocol (“IP”) address had been previously received, then the constraint filter result increments a count and then determines if the count is above a predetermined threshold during a predetermined threshold time period;
a control function that provides a control signal to drop at least one data packet from the system based on the detection function determining that the count is above a predetermined threshold during a predetermined threshold time period; and
at least one processor that provides the header parsing function, the constraint filter function, the detection function, and the control function.

2. The malicious attack detection system according to claim 1, wherein the potential malicious attack condition includes a denial of service (“DoS”) attack.

3. The malicious attack detection system according to claim 1, wherein the potential malicious attack condition includes a port scan.

4. The malicious attack detection system according to claim 1, wherein at least one of the header parsing function, the constraint filter function, the detection function, and the control function is conducted at wire-speed.

5. The malicious attack detection system according to claim 1, wherein the constraint filter function includes a plurality of constraint conditions that can be selectively activated.

6. The malicious attack detection system according to claim 1, wherein the detection function includes a plurality of counters and a corresponding plurality of threshold counter value comparisons and an associated time interval filter function with a plurality of time intervals and a corresponding plurality of threshold time interval values.

7. The malicious attack detection system according to claim 1, wherein the header information is received by at least one first-in/first-out memory buffer.

8. The malicious attack detection system according to claim 1, further comprising an update and storage function, provided by the at least one processor, that revises a listing of internet protocol (“IP”) addresses that are utilized by the comparison function.

9. The malicious attack detection system according to claim 1, wherein the comparison function utilizes at least one content-addressable memory (“CAM”).

10. The malicious attack detection system according to claim 1, further comprising a report function, provided by the at least one processor, that provides a report of the type of imminent malicious attack prior to dropping at least one data packet from the system, wherein the type of malicious attack is selected from the group consisting of a denial of service (“DoS”) attack or a port scan.

11. The malicious attack detection system according to claim 1, further comprising a report function, provided by the at least one processor, that can be utilized to indicate at least one dropped data packet from the system.

12. The malicious attack detection system according to claim 1, further comprising an output function, provided by the at least one processor, to provide an indication of the at least one dropped data packet from the system.

13. The malicious attack detection system according to claim 1, further comprising an interface, associated with the at least one processor, for providing control for the constraint filter function and the detection function.

14. The malicious attack detection system according to claim 1, further comprising an interface, associated with the at least one processor, for providing control for the constraint filter function, the control function and a first report function that provides a first report function of the type of imminent malicious attack prior to dropping at least one data packet from the system, wherein the type of malicious attack is selected from the group consisting of a denial of service (“DoS”) attack or a port scan and a second report function that can be utilized to indicate at least one dropped data packet from the system, wherein the first report function and the second report function can be provided by the at least one processor.

15. A malicious attack detection system comprising:
a header parsing function for receiving and parsing a header frame of a data packet into header information and internet protocol (“IP”) addresses at wire-speed;
a constraint filter function that checks the header information at wire-speed for a potential malicious attack condition, wherein if a potential malicious attack condition is present then a constraint filter result is generated, wherein the potential malicious attack condition is selected from the group consisting of a denial of service (“DoS”) attack or a port scan, wherein the constraint filter function includes a plurality of constraint conditions that can be selectively activated;
a comparison function compares the internet protocol (“IP”) addresses, at wire-speed, to determine if an internet protocol (“IP”) address had been previously received;
a detection function, operating at wire-speed, that determines that if the comparison function had determined that an internet protocol (“IP”) address had been previously received, then the constraint filter result increments a count and then determines if the count is above a predetermined threshold during a predetermined threshold time period, wherein the detection function includes a plurality of counters and a corresponding plurality of threshold counter value comparisons and an associated time interval filter function with a plurality of time intervals and a corresponding plurality of threshold time interval values;
a control function, operating at wire-speed, that provides control signal to drop at least one data packet from the system based on the detection function determining that the count is above a predetermined threshold during a predetermined threshold time period;
at least one processor that provides the header parsing function, the constraint filter function, the detection function and the control function; and
an interface associated with the at least one processor for providing control for the constraint filter function and the control function.

16. A method for detecting a malicious attack with at least one processor comprising:
receiving and parsing a header frame of a data packet into header information and internet protocol (“IP”) addresses;
checking the header information for a potential malicious attack condition, wherein if a potential malicious attack condition is present then a constraint filter result is generated;
comparing the internet protocol (“IP”) addresses to determine if an internet protocol (“IP”) address had been previously received;
determining if during the step of comparing the internet protocol (“IP”) addresses that an internet protocol (“IP”) address had been previously received;
determining the number of constraint filter results to determine if an incremented count is above a predetermined threshold during a predetermined threshold time period; and
dropping at least one data packet from the system based on the detection function determining that the count is above a predetermined threshold during a predetermined threshold time period.

17. The method for detecting a malicious attack with at least one processor according to claim 16, wherein the potential malicious attack condition includes a denial of service (“DoS”) attack.

18. The method for detecting a malicious attack with at least one processor according to claim 16, wherein the potential malicious attack condition includes a port scan.

19. The method for detecting a malicious attack with at least one processor according to claim 16, wherein the detecting of a malicious attack with at least one processor occurs at wire-speed.

20. The method for detecting a malicious attack with at least one processor according to claim 16, further comprising selectively activating a plurality of constraint conditions after the determining the number of constraint filter results.

21. The method for detecting a malicious attack with at least one processor according to claim 16, wherein the determining the number of constraint filter results to determine if an incremented count is above a predetermined threshold during a predetermined threshold time period includes utilizing a plurality of counters and a corresponding plurality of threshold counter value comparisons and a plurality of time intervals and a corresponding plurality of threshold time interval values.

22. The method for detecting a malicious attack with at least one processor according to claim 16, further comprising receiving the header information with at least one first-in/first-out memory buffer.

23. The method for detecting a malicious attack with at least one processor according to claim 16, further comprising updating and storing a listing of internet protocol (“IP”) addresses.

24. The method for detecting a malicious attack with at least one processor according to claim 16, wherein the comparing the internet protocol (“IP”) addresses to determine if an internet protocol (“IP”) address had been previously received includes utilizing at least one content-addressable memory (“CAM”).

25. The method for detecting a malicious attack with at least one processor according to claim 15, further comprising at least one of a generating a first report of the type of malicious attack prior to dropping at least one data packet from the system, generating a second report indicating at least one dropped data packet from the system and an output indicating at least one dropped data packet from the system.

26. A method for detecting a malicious attack with at least one processor comprising:
receiving and parsing a header frame of a data packet into header information and internet protocol (“IP”) addresses at wire-speed;
checking the header information for a potential malicious attack condition at wire-speed, wherein if a potential malicious attack condition is present then a constraint filter result is generated through a selective activation of plurality of constraint conditions and the potential malicious attack condition is selected from the group consisting of a denial of service (“DoS”) attack or a port scan;
comparing the internet protocol (“IP”) addresses to determine if an internet protocol (“IP”) address had been previously received at wire speed;
determining if during the step of comparing the internet protocol (“IP”) addresses that an internet protocol (“IP”) address had been previously received at wire-speed;
determining the number of constraint filter results to determine if an incremented count is above a predetermined threshold during a predetermined threshold time period at wire speed; and
dropping at least one data packet from the system, at wire speed, based on the detection function determining that the count is above a predetermined threshold during a predetermined threshold time period with a plurality of counters and a corresponding plurality of threshold counter value comparisons and a plurality of time intervals and a corresponding plurality of threshold time interval values.
